(19) United States
(12) Patent Application Publication
(10) Pub. No.: US 2008/0309011 A1
(43) Pub. Date: Dec. 18, 2008

(54) CARD GAME

(76) Inventor: Anthony CRAWFORD, Oakville (CA)

Correspondence Address: LANG MICHENER, BCE PLACE, P.O. BOX 747, SUITE 2500, 181 BAY STREET, TORONTO, ON, M5J 2T7, CA

(21) Appl. No.: 12/137,887

(22) Filed: Jun. 12, 2008

Related U.S. Application Data
(60) Provisional application No. 60/943,350, filed on Jun. 12, 2007.

(51) Int. Cl. A63F 1/00; G09B 19/22

(52) U.S. Cl. 273/304; 434/129

(57) ABSTRACT

The invention consists of a novel card game using a 54-card deck of 52 standard playing cards and two Jokers. Each card is assigned a monetary value, based on the face value of the card. In the standard game, each card is valued at $10,000 times the face value, with Jacks equal to $110,000; Queens equal to $120,000; Kings equal to $130,000; and Aces equal to $10,000. Jokers have no monetary value. The suit of the card has no bearing on the game. The specific value of the cards can be adjusted to reflect to the total money allocated to each player at the start of the game.

### FIELD OF THE INVENTION

The present invention relates to the field of card games. In particular, it relates to a novel card game for illustrating the concept of “identity theft” using bank loan mechanics and credit and debit cards.

### BACKGROUND OF THE INVENTION

One of the many methods of informing and educating people is to incorporate the information into a game, often a card or board game. By participating in the game, the players are exposed to the desired information in a natural process, and can learn and remember information more effectively in the informal atmosphere of the game.

In view of the complexities of banking laws and systems, and the rise in so-called “identity theft” resulting from stolen credit/debit cards and the increase in transmission of personal information via the Internet, there is a need for the public to become more aware of their local banking laws and the risks they are exposed to thereunder. Ideally, a card or board game related to banking law would provide the system for informing and educating the general public.

It is an object of this invention to partially or completely fulfill one or more of the above-mentioned needs.

### SUMMARY OF THE INVENTION

The invention consists of a novel card game using a 54-card deck of 52 standard playing cards and two Jokers. Each card is assigned a monetary value, based on the face value of the card. In the standard game, each card is valued at $10,000 times the face value, with Jacks equal to $110,000; Queens equal to $120,000; Kings equal to $130,000; and Aces equal to $10,000. Jokers have no monetary value. The suit of the card has no bearing on the game. The specific value of the cards can be adjusted to reflect to the total money allocated to each player at the start of the game.

Additionally, face cards and certain other cards have special properties beyond their listed monetary value. Aces (A), Kings (K) and Queens (Q) are “Affiant” cards, Jacks (J) are “Debtor” cards, Tens are “Identity” cards and Eights are “Witness” cards. The Jokers are “Insurance” cards.

In order to complete a hand, one player must hold a combination of A, K, J plus another “Affiant” cards (A, K or Q). Thus, the valid hands are A, K, Q, J; A, K, K, J; or A, K, A, J. When one player gains one of these combinations, that player is the “Winner”, all other players are “Losers”, the hand ends, all hands are turned face-up, and scoring for the hand takes place. Once scoring is completed, the cards are shuffled and dealt to start a new hand.

Each “Loser” player pays the value of the cards in their hand to the bank, with the “Winner” player receiving 10% of the total collected, plus the value of their own hand. There are two exceptions: 1) a “Loser” player whose hand contains a Joker is insured, and does not pay any money to the bank, although the value of the hand is still contributed to the bank and counts for the “Winner”; 2) A “Loser” player whose hand totals $80,000 or less does not pay any money and their hand does not count for the bank or the “Winner”.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is the card-back of the present game using “Plastic Rules”;

FIG. 2 is an Ace of Diamonds according to the rules of the “Plastic Rules” game;

FIG. 3 is a King of Clubs according to the rules of the “Plastic Rules” game;

FIG. 4 is a Queen of Hearts according to the rules of the “Plastic Rules” game;

FIG. 5 is a Jack of Diamonds according to the rules of the “Plastic Rules” game;

FIG. 6 is a Joker—Rules Card according to the rules of the “Plastic Rules” game;

FIG. 7 is the card-back of the present game “Affiant Rules”;

FIG. 8 is an Ace of Clubs according to the rules of the “Affiant Rules” game;

FIG. 9 is a King of Diamonds according to the rules of the “Affiant Rules” game;

FIG. 10 is a Queen of Spades according to the rules of the “Affiant Rules” game;

FIG. 11 is a Jack of Clubs according to the rules of the “Affiant Rules” game;

FIG. 12 is a Ten of Diamonds according to the rules of the “Affiant Rules” game;

FIG. 13 is an Eight of Clubs according to the rules of the “Affiant Rules” game;

FIG. 14 is a Joker according to the rules of the “Affiant Rules” game;

FIG. 15 is a game scorecard formatted to playing card size;

FIG. 16 is a rules card for the game formatted to playing card size; and

FIG. 17 is a second rules card continued from FIG. 16.

### DETAILED DESCRIPTION OF THE PREFERRED EMBODIMENTS

The inventive card game present herein is played using a deck of 52 cards, including the two joker cards, for 54 cards in total. A standard deck can be used, or a customized deck labeled according to the rules of the game. The game is designed for 2-8 players, with 4-6 players being optimal for balanced play.

The purpose of the game is to illustrate the ability of banks to provide loans based on notarized statements of affiants without further supporting documentation, as is enabled by banking agency law in many countries. This ability creates difficulties in cases of identity theft, where a loan can be made under a person's identity without their knowledge.

Each player is dealt four cards, which are kept concealed from the other players. The remainder of the deck is placed face-down in the center of the players as a draw pile, and the top card of the draw pile is turned face-up and placed adjacent to the draw pile create a discard pile. Each player is further allocated $2,000,000 to their bank account, an amount represent their “lifetime” income. The amount and currency of the starting allocation can be varied to reflect local requirements.

Play begins at the first player, chosen in any desired manner. The first player chooses to either take the top card of the draw pile, or the top card of the discard pile. Once a card is taken, a card from the hand, which can be the card taken if that card is from the draw pile, is placed face-up on the top of the discard pile. Play then passes to the next player until the hand is completed. Thus, each play always has four cards in their hand.

Each card is assigned a monetary value, based on the face value of the card. In the standard game, each card is valued at $10,000 times the face value, with Jacks equal to $110,000; Queens equal to $120,000; Kings equal to $130,000; and Aces equal to $10,000. Jokers have no monetary value. The suit of the card has no bearing on the game. The specific value of the cards can be adjusted to reflect to the total money allocated to each player at the start of the game.

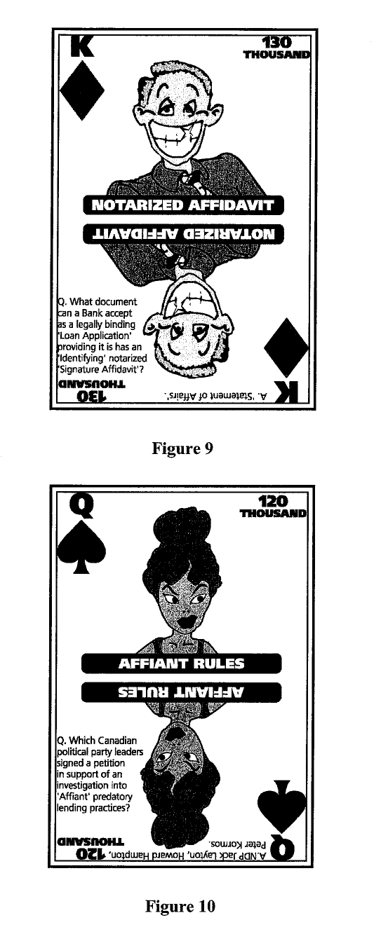

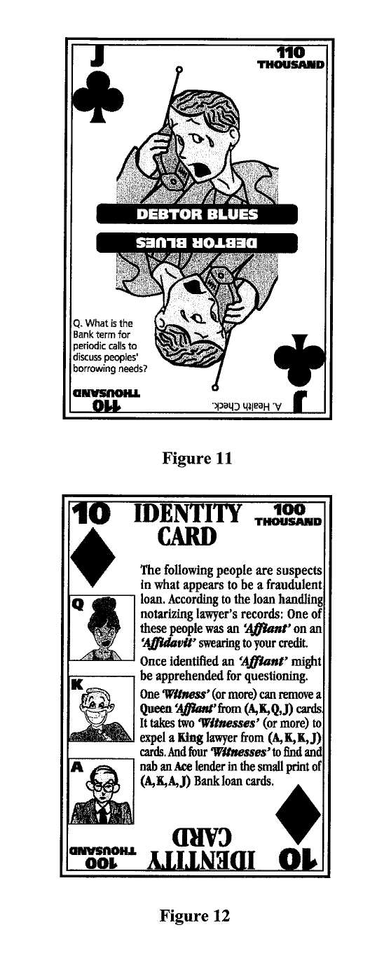

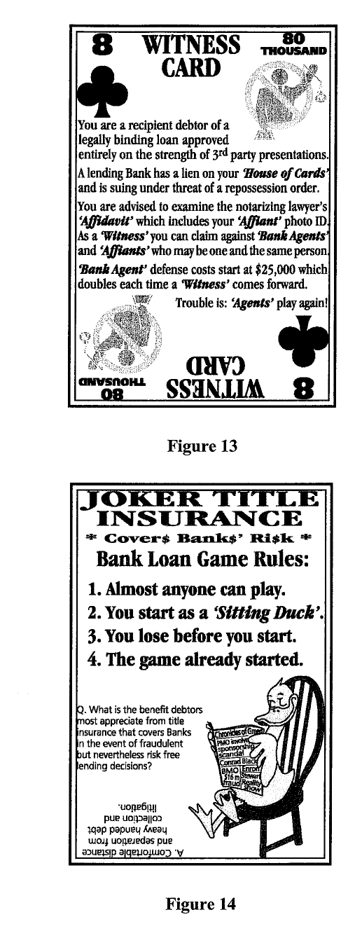

Additionally, face cards and certain other cards have special properties beyond their listed monetary value. Aces (A) (FIG. 8), Kings (K) (FIG. 9) and Queens (Q) (FIG. 10) are “Affiant” cards, Jacks (J) (FIG. 11) are “Debtor” cards, Tens (FIG. 12) are “Identity” cards and Eights (FIG. 13) are “Witness” cards. The Jokers (FIG. 14) are “Insurance” cards.

Preferably, the cards contain explanations of their function within the rules of the game. Furthermore, all cards can contain facts or question-and-answer type factoids related to banking laws.

In order to complete a hand, one player must hold a combination of A, K, J plus another “Affiant” card (A, K or Q). Thus, the valid hands are A, K, Q, J; A, K, K, J; or A, K, A, J. When one player gains one of these combinations, that player is the “Bank Agent” and the “Winner”, all other players are “Losers”, the hand ends, all hands are turned face-up, and scoring for the hand takes place. Once scoring is completed, the cards are shuffled and dealt to start a new hand.

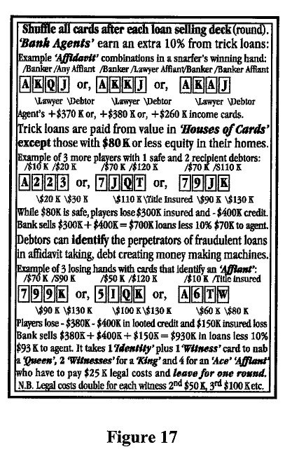

The rules are preferably provided on one or two cards included with the deck, as shown in FIGS. 16 and 17. The rules can be on separate cards or on a single, double-sided card.

### Scoring

Each “Loser” player pays the value of the cards in their hand to the bank, with the “Winner” player receiving 10% of the total collected as “Bank Agent”, plus the value of their own hand. There are two exceptions: 1) a “Loser” player whose hand contains a Joker is insured, and does not pay any money to the bank, although the value of the hand is still contributed to the bank and counts for the “Winner”; 2) A “Loser” player whose hand totals $80,000 or less does not pay any money and their hand does not count for the bank or the “Winner”.

Each player starts with $2,000,000, as set out above, and the bank starts with $0. As the game progresses, the players will gradually lose money, while the bank continually gains. At the end of the game, the player with the most money is declared the winner, however, in the majority of games, the bank will have the most money and, thus, none of the players win.

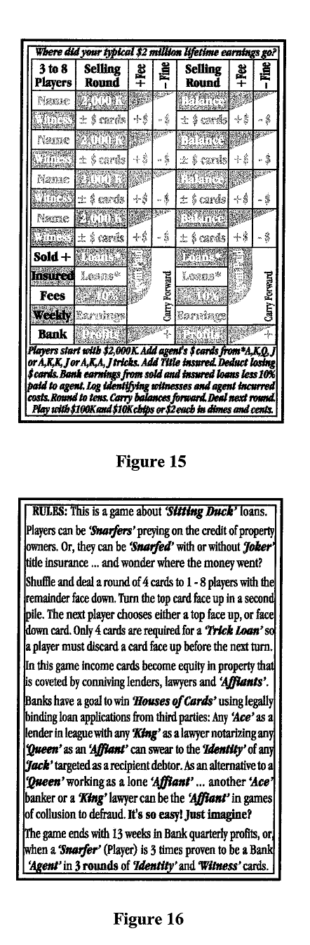

Score can be kept using chips representing $100,000 and $10,000, respectively. Alternatively, a scorecard can be used. A sample scorecard, sized to match a standard playing card, is shown in FIG. 15.

### Ending the Game

The game can end in any number of agreed-upon ways. The most common way is to play a fixed number of hands, generally twice the number of players (e.g. 8 hands for four players) or 13, to reflect the number of weeks in a bank's quarterly report. Another way is to end when the first player runs out of money. Alternatively, both ways can be used, with the game ending before the fixed number of hands is player if one or more players run out of money. The starting value of $2,000,000 per player can be modified to change the game length as well.

### Additional Rules

The “Witness” (10) and “Identity” (8) cards are used to modify the score and subsequent hands after the first. Here, the “Bank Agent” and the “Affiant” are assumed to be in collusion, or one and the same person.

If one of the “Loser” players has an “Identity” card in their hand, they can attempt to remove the “Affiant” card used in the “Winner” player's hand from play. The ability to remove the card is based on the number of “Witness” cards showing in all players' hands and the specific “Affiant” card used by the “Winner”. For a Queen Affiant, one Witness card is needed, for a King, two, and for an Ace, all four Witness cards must be showing.

If the “Loser” player has an Identity card and sufficient Witness cards are showing, the Affiant card is removed from play for the next hand, after which it is returned to the game. Furthermore, the “Winner” must pay legal costs, starting at $25,000, and doubling with each subsequent removal over the course of the game.

These rules allow for another variation (“Three Strikes”) in ending the game. If one player is able to successfully remove the Affiant from the same “Winner” player three times in the course of one game, the game ends, with the “Winner” player being eliminated from the game (money set to zero). Alternatively, the game can continue, with the remaining players until another of the game ending objectives is reached.

### Strategy

There are two different strategies, either to attempt to be the “Winner” player, or to be a “Loser” player who does not have to pay money to the bank. The first strategy requires collecting face cards to achieve one of the “Winner” combinations. If successful, the player gains money, and increases their odds of staying in the game. However, there are risks, if another player achieves the “Winner” combination, the value of the players hand will be quite large, resulting in a substantial amount of the player's money being paid to the bank. Another risk is, as the game goes through several hands, if several Affiants have been removed, the fine to the “Bank Agent” becomes very large, and the amount of the fine can exceed the gains achieved by having the “Winner” hand.

An alternative strategy is to play a “Loser” hand. The best hand is achieved by gaining one of the Jokers, which ensures the player will not have to pay any money at the end of the hand. Another option is to reduce the value of the cards in the hand to $80,000 or less, which also means that no money will be owed. This also has the effect of keeping Ace cards (valued at $10,000) from those collecting them for “Winner” hands.

A third strategy is to collect an Identity card (10) and as many Witness cards (8) as possible in an attempt to knock out the Affiant card from the “Winner” hand. This makes future hands slightly more difficult, and increases the fine against the “Winner” for each successful removal. This strategy is best executed by players who hold a Joker, as the value of the Identity card otherwise ensures that the player will owe money as a “Loser”.

### Variants

### Credit Card Game—“Plastic Rules”

In the credit card variant of the game, cards are designed for an educational purpose relating to methods of identity theft arising from compromised credit and debit cards. Each playing card represents a plastic credit card. Hence, the name of the game variant as “plastic rules”.

Players are dealt four cards, which are kept concealed from the other players. The remainder of the deck is placed face-down in the center of the players as a draw pile, and the top card of the draw pile is turned face-up and placed adjacent to the draw pile create a discard pile.

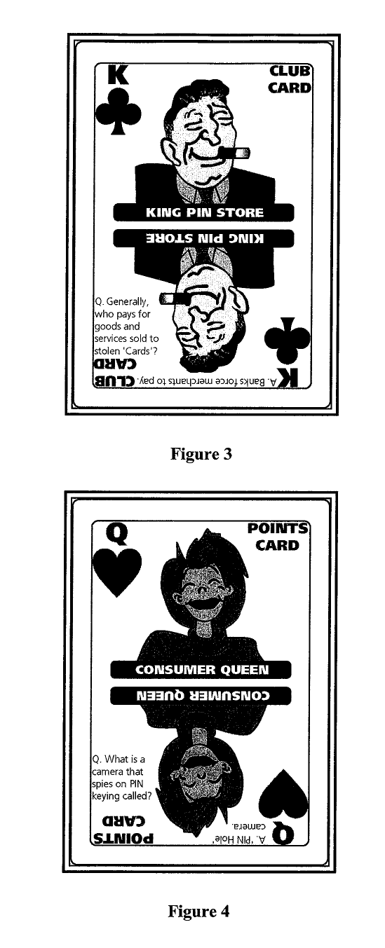

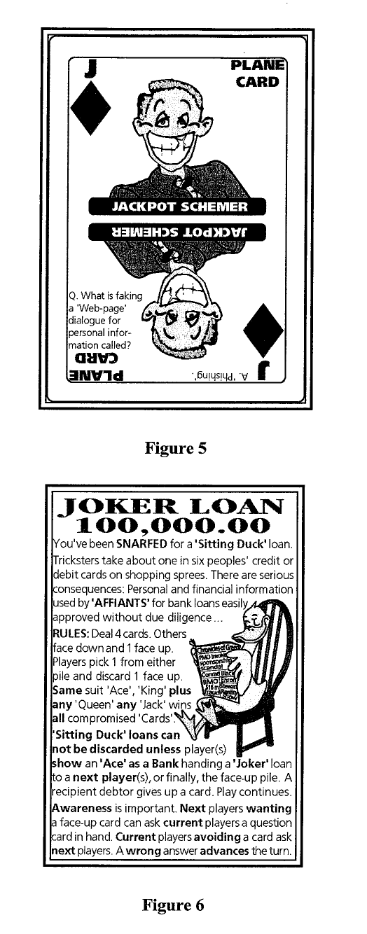

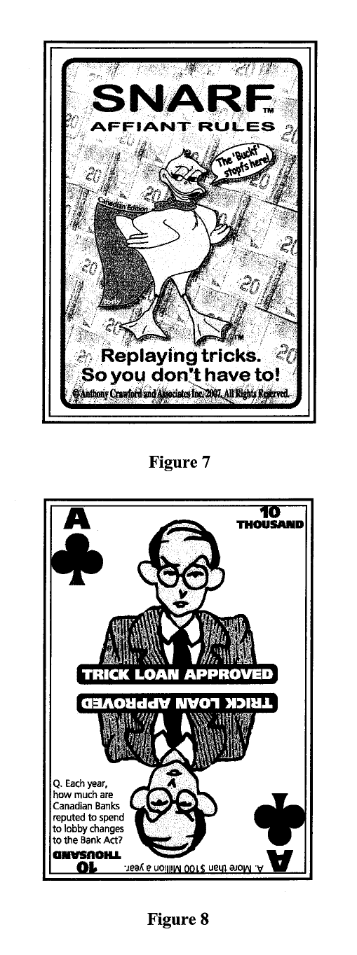

Aces (A) are “Bankers” (FIG. 2), Kings (K) are “Merchants” (FIG. 3), Queens (Q) are “Consumers” (FIG. 4), Jacks (J) are “Hackers” (FIG. 5) and Jokers are fraudulent “Loan” cards (FIG. 6).

In order to complete a hand, one player must hold a combination of same suit A, and K, plus any Q and any J. When one player gains one of these combinations, all “Credit” cards are compromised and given to “Winner” player. There is no scoring.

Jokers represent fraudulent “loans” implemented from stolen “Identities”. A Joker “loan” picked up from a face-down deck is not discarded unless a player can show an Ace as a “banker” handing the “loan” on to the next player. A Joker can be passed round until it is picked up by a player without an Ace, or is finally returned to the face-up pile. A recipient “debtor” burdened with a Joker “loan” gives up a card and play continues.

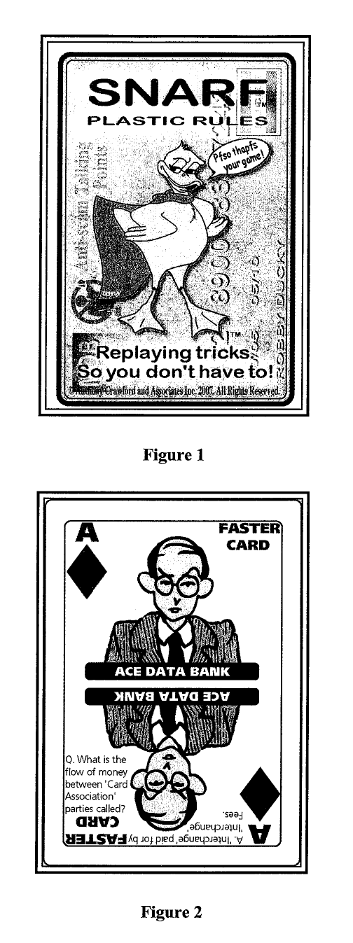

All cards are coded on the back as marked cards (FIG. 1). One Joker is discernible from the other Joker with a special marked card-back.

### The Savings and Loans Game—“Golden Rules”

In the savings and loan variant of the game, cards are designed for an educational purpose relating to methods of Identity Theft arising from compromised customer information. Each playing card represents a savings and loans account. Hence the name of the game variant as “Golden Rules”.

The rules are the same as “Plastic Rules” with the only difference in the character roles of picture cards.

### The Lending Game—“Affiant Rules”

In the lending variant of the game, cards are designed for an educational purpose relating to “Affidavits” as they are used to establish loans by ways of sworn “Powers of Attorney” and “Signatures”, etc. The game demonstrates the role of a perpetrator of fraud acting as a “Bank Agent” known as an “Affiant”. Hence the name of the game version “Affiant Rules”.

“Question and Answer” or “QA” cards are provided separately or integrated as questions and answers on each of the cards in play. Additionally, the game scoring method illustrates Bank law and lending practices.

### Educational Components

The “QA” cards can also be used strategically as part of the game. The next players wanting to pick up face-up cards can ask the Current players a question from a card in hand. Also, a Current player wanting to avoid picking up either face-up or face-down cards can ask a Next player a question from a card in hand. A Wrong answer advances the turn.

Additional “Jokers” add to the educational component. These are considered as “Ultimate Jokers” and have no part in the game rules except in “End Game” options based on information from the card made known to all players. The player holding such a “Joker” reads the question card for any other player, or players to answer. After discussion, the player with the “Ultimate Joker” card puts it aside, and picks another card to resume play for the game to continue.

### Multi-Deck Variations

The game can be further adapted to multi-deck variations, known as “Mamonas Rules”. The “Affiant Rules” version can be played with two or more marked decks including either or both of the “Plastic Rules” variant based on credit cards and the “Golden Rules” variant based on savings and loans. These extra cards are picked from separate or combined shuffled decks. They are placed face down in front of each player as they are picked. These face down “Marked” cards represent credit card transactions and personal savings and loans accounts while playing “Affiant Rules”. They do not score in the game. However, as the face down cards are discernible from the card-backs, a player can win the game picking a “Bank” same suit “Ace” or a “King” as a required “Affiant” drawn from any other player's face down cards.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but only by the claims that follow.

I claim:

1. A method of playing a card game for two or more players, comprising:
a) designating each card in a deck of cards, based on a standard deck of 52 playing cards ranked from Ace to King, with a monetary value equal to a fixed amount times its numerical face value, with numerical values for Ace=1, Jack=11, Queen=12 and King=13, and assigning each player a predetermined amount of starting money;
b) further designating Aces, Kings, and Queens as “Affiant” cards, and Jacks as “Debtor” cards;
c) dealing each player four cards from the deck to form a hand, and placing the remainder of the deck face down as a draw pile, with the top card of the draw pile then turned face up and set down to form a discard pile;
d) in turn, each player taking a card from one of the draw pile and the discard pile into their hand, and then discarding a card from their hand to the discard pile;
e) repeating step d) until one player holds a hand comprised of Ace, King, Jack, and another Affiant card, designating that player as “Winner” and all other players as “Loser”;
f) scoring each hand, with each Loser paying to a Bank an amount equal to the combined value of all cards in their hand if greater than a predetermined monetary value, and the Winner collecting an amount equal to their hand plus 10% of the amount paid to the Bank; and
g) repeating steps c) to f) as rounds until predetermined conditions for terminating the card game are reached.

2. The method of claim 1, wherein the deck further includes two Joker cards, for a total of 54 playing cards, and the Jokers are designated as “Insurance” cards with a monetary value of $0, and a Loser with an Insurance card in their hand pays no money to the bank, with the amount of their hand still counting for the amount collected by the Winner.

3. The method of claim 1, wherein the predetermined condition for terminating the card game is one player reaching $0 from a predetermined starting amount.

4. The method of claim 3, wherein the fixed amount is $10,000, the predetermined monetary value is $80,000 and the predetermined starting amount is $2,000,000.

5. The method of claims 1, wherein the predetermined condition for terminating the card game is playing a number of rounds equal to twice the number of players.

6. The method of claim 1, further including designating Tens as “Identity” cards and Eights as “Witness” cards and including the ability for a Loser to play an Identity card from their hand to remove the another Affiant card from the Winner's hand, taking that another Affiant card out of play for the next round, if a sufficient number of Identity cards are showing in all of the combined Loser hands.

7. The method of claim 6, where one Identity card is required to remove a Queen Affiant card, two Identity cards are required to remove a King Affiant card, and four Identity cards are required to remove an Ace Identity card.

8. The method of claim 6, wherein one predetermined condition for terminating the game is for the same Winner to have the another Affiant card removed from their hand three times, at which point the same Winner has their money set to $0.

9. The method of claim 1, wherein each card is further labeled with a question and an answer in subject matter related to one or more of: banking, law and politics.

10. The method of claim 9, wherein the question is educationally derived in such a fashion as to raise public awareness with respect to the subject matter.

11. The method of claim 9, further including, prior to step d), enabling a player to skip their turn by correctly answering a questions from a card in the hand of the player with the next turn.

12. The method of claim 1, wherein three decks of cards are used, each deck being designated according to step a), each deck having its own draw pile and discard pile.

13. The method of claim 1, further including playing a playing surface labeled with locations for the draw pile and the discard pile for each deck.

14. The method of claim 2, further including designating Tens as “Identity” cards and Eights as “Witness” cards and including the ability for a Loser to play an Identity card from their hand to remove the another Affiant card from the Winner's hand, taking that another Affiant card out of play for the next round, if a sufficient number of Identity cards are showing in all of the combined Loser hands.

15. The method of claim 2, wherein each card is further labeled with a question and an answer in subject matter related to one or more of: banking, law and politics.

16. The method of claim 6, wherein each card is further labeled with a question and an answer in subject matter related to one or more of: banking, law and politics.

17. The method of claim 2, wherein three decks of cards are used, each deck being designated according to step a), each deck having its own draw pile and discard pile.

18. The method of claim 2, further including playing a playing surface labeled with locations for the draw pile and the discard pile for each deck.

19. The method of claim 6, wherein three decks of cards are used, each deck being designated according to step a), each deck having its own draw pile and discard pile.

20. The method of claim 6, further including playing a playing surface labeled with locations for the draw pile and the discard pile for each deck.
